(19) United States
(12) Patent Application Publication
(10) Pub. No.: US 2013/0119694 A1
(43) Pub. Date: May 16, 2013

(54) DRIVE ASSEMBLY FOR EXPANDABLE ENCLOSURE

(71) Applicant: Bernard F. Garceau, Vandalia, MI (US)

(72) Inventor: Bernard F. Garceau, Vandalia, MI (US)

(73) Assignee: Norco Industries, Inc., Compton, CA (US)

(21) Appl. No.: 13/294,622

(22) Filed: Nov. 11, 2011

(51) Int. Cl. B60P 3/34; F16H 19/02

(52) U.S. Cl. 296/26.13; 74/89.2

(57) ABSTRACT

A drive system for an expandable enclosure having a slide out, the drive system including a first guide, a second guide spaced from the first guide, a drive wheel supported between the first and second guides and inward thereof, and a belt operatively engaging the drive wheel and having a first end and a second end, where the first end extends outward from the drive wheel and over the first guide and the second end extends outward from the drive wheel and over the second guide, each of the ends being attachable to the slide out, where the drive wheel is rotatable to move the belt to move the slide out.

### TECHNICAL FIELD

In general, the present invention relates to a drive assembly for a slide out in an expandable enclosure. More particularly, the present invention relates to a drive assembly that includes a belt drive system. Most particularly, the present invention relates to a drive assembly having a belt attachable to a slide out at either end of the belt, the belt having teeth formed thereon and a drive wheel that has cogs formed on it that engage the teeth and move the slide out by pulling the belt in one direction or another.

### BACKGROUND OF THE INVENTION

Expandable enclosures are often used in connection with recreational vehicles or trailers that have portions that extend and retract to allow the enclosure to be transported in a compact configuration and extended to a more spacious configuration when stationary. To that end, these recreation vehicles and trailers are provided with slide outs including slidable rooms and other structures that increase or reconfigure the usable space. Existing slidable rooms and other slide outs may be time consuming to install and their operating mechanisms may include components that add a great deal of weight and complexity to the enclosure. Since most enclosures having slide outs are used in applications where they need to be transported, it is desirable to reduce the weight of the enclosure as practically as possible. Likewise, reducing the complexity of the slide out drive assembly is desirable in terms of the labor needed to install the drive assembly and operation of the drive assembly by the user.

### SUMMARY OF THE INVENTION

The present invention generally includes drive system for an expandable enclosure having a slide out, the drive system including a first guide, a second guide spaced from the first guide, a drive wheel supported between the first and second guides and inward thereof, and a belt operatively engaging the drive wheel and having a first end and a second end, where the first end extends outward from the drive wheel and over the first guide and the second end extends outward from the drive wheel and over the second guide, each of the ends being attachable to the slide out, where the drive wheel is rotatable to move the belt to move the slide out. The present invention also includes a drive system for an expandable enclosure. The drive system includes a cartridge having a pair of sidewalls with a first pin and a second pin extended between the sidewalls. A first roller slideably supported on the first pin, where the first pin has a length greater than a length of the first roller. A second roller slideably supported on the second pin, where the second pin has a length greater than a length of the second roller. A drive wheel supported between the first and second rollers and outward thereof. A belt operatively engaging the drive wheel and having a first end and a second end, where the first end extends outward from the first roller and the second end extends outward from the second roller. Each of the ends are attachable to the expandable enclosure. The drive wheel is rotatable to move the belt.

In accordance with another embodiment, a cartridge and a drive system having a belt for an expandable enclosure is provided. The cartridge includes a first sidewall and a second sidewall; a first pin extended between the first sidewall and a second sidewall; a first roller defining a first roller bore through which the first pin is received, wherein the first roller is slideable along the first pin between the first sidewall and the second sidewall; and a drive wheel supported between the first sidewall and the second sidewall, the drive wheel being engagable with the belt and rotatable to effect movement of the expandable enclosure via the belt.

In another embodiment of the invention, an expandable enclosure includes a main enclosure defining an opening; a slide out received in the opening; a jamb defining a side of the opening, the jamb including a face, a first wall and a second wall extending outward from the face, defining a channel there between wherein the face defines a first belt opening. A cartridge is mounted within the channel adjacent to the first belt opening, a cartridge having a first sidewall and a second sidewall, a first pin extending between the first sidewall and the second sidewall, a first roller mounted on the first pin and slideable between the first wall and the second wall, and a drive wheel supported between the first sidewall and the second sidewall, the drive wheel having an axis of rotation parallel to the first roller, where in the drive wheel is mounted outward of the first roller. The cartridge also includes a belt operatively engaging the drive wheel, wherein a portion of the belt extends from the drive wheel and over the first roller before existing the belt opening. The portion of the belt is attached to the slide out.

### BRIEF DESCRIPTION OF THE DRAWINGS

FIG. 1 is a perspective exterior view of a portion of an expandable enclosure having a slide out according to the present invention, showing the slide out in a fully extended position;

FIG. 2 is a rear perspective view of an enclosure having a drive assembly according to the invention where the slide out has been removed to show details of the drive assembly and the surrounding frame;

FIG. 3 is a side view of a slide out as shown in FIG. 1, where portions of the expandable enclosure have been removed to show details of the jamb and drive assembly of the present invention;

FIG. 4 is a section view as might been seen along line 4-4 in FIG. 3;

FIG. 5 is an enlarged perspective view of an interior of a jamb depicting further details of the drive assembly;

FIG. 6 is an enlarged perspective view of an exterior of a jamb depicting further details of the drive assembly. DETAILED DESCRIPTION

An “enclosure” as used herein may include any partially or completely enclosed space. The enclosure may be stationary or mobile. Mobile enclosures may be self-powered or towable, and include but are not limited to mobile homes, recreational vehicles, and trailers. The term “expandable enclosure” refers to an enclosure that has the ability to alter its configuration and in some cases create more interior space. For example, an expandable enclosure may include one or more portions that extend and retract to selectively reconfigure the space defined by the enclosure. These portions are often referred to as “slide outs” or “slideable rooms.” A slide out may include a portion that is moved relative to the enclosure to change the configuration of the enclosure including but not limited to increasing the space available within the enclosure. Slide outs may be of various size and shape as required by a given enclosure. Also, slide outs may expand and retract in any known manner including, but not limited to pivoting and telescoping relative to the main portion of the enclosure. The example shown in the accompanying drawings, therefore, should not be considered limiting.

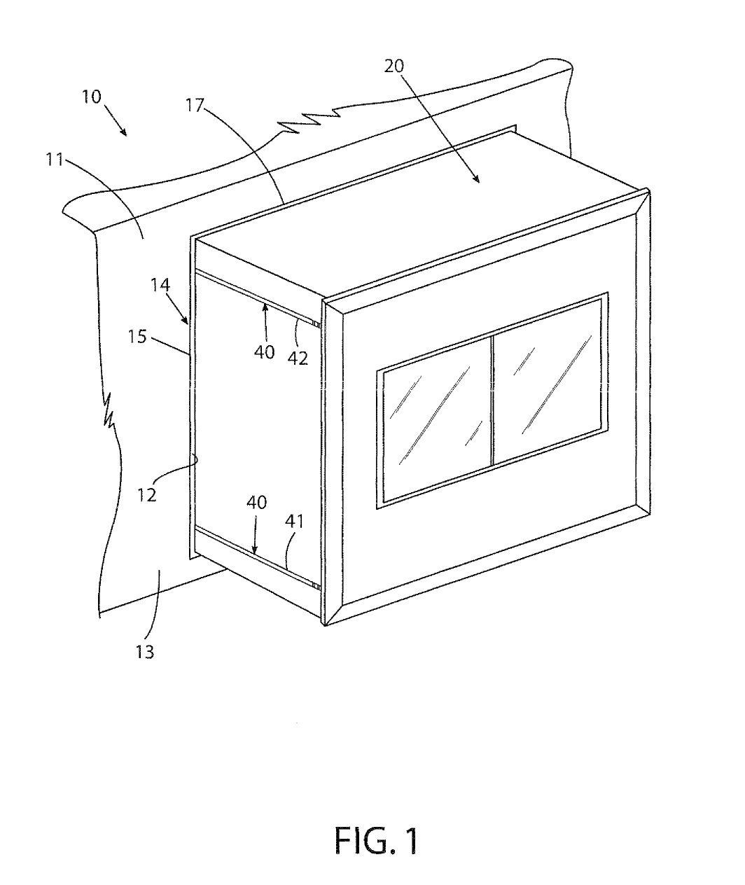

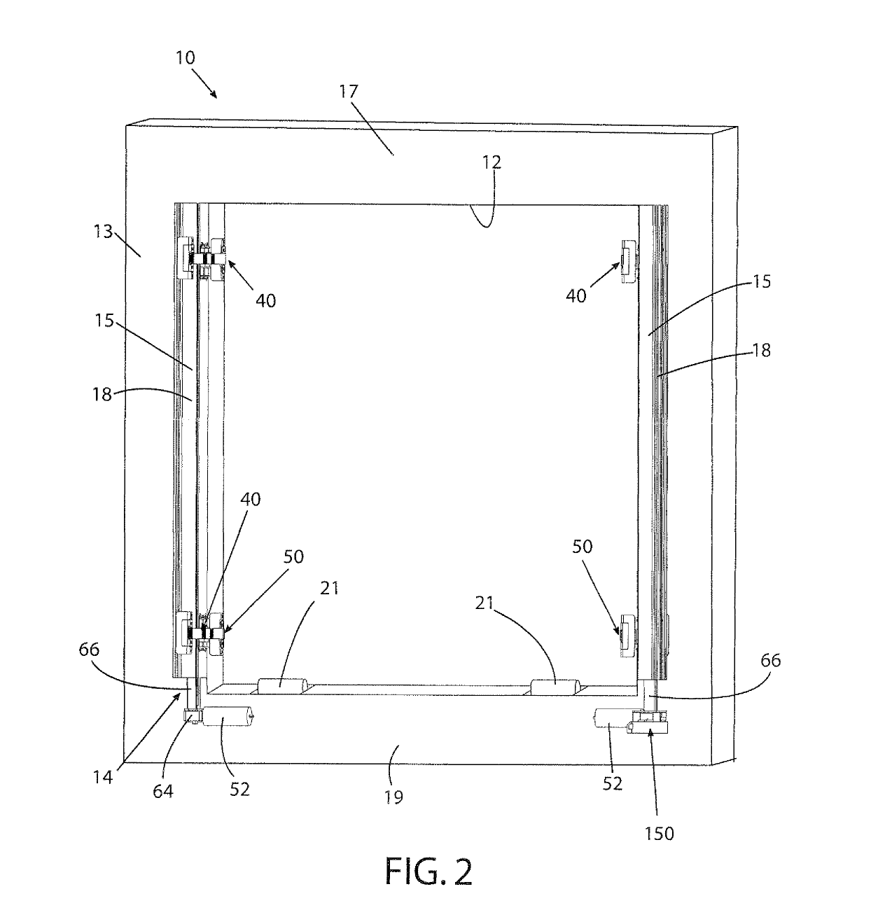

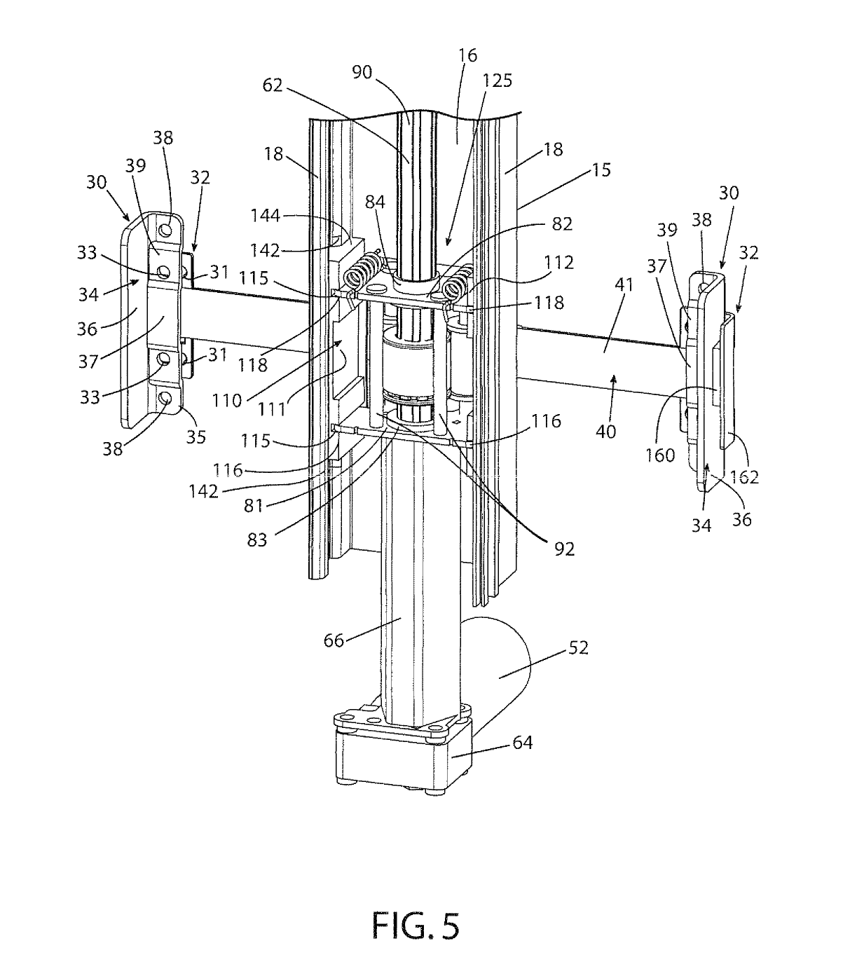

FIG. 1 shows a portion of a expandable enclosure having a slideable room or slide out 20 in an extended position. During movement or transport of the enclosure 10, the slide out is normally fully retracted into the enclosure 10 to make the enclosure more compact. The enclosure wall 13 has an opening 12 into which the slide out 20 fits. Positioned about the edges of the opening 12 is a frame 14. The frame 14 includes a pair of jambs 15 on each side that may be used to house one or more drive assemblies, which will be discussed in more detail below. As shown, jambs 15 may be channel-like members having a face 16 adjacent to the slide out opening 12 and outward extending walls 18. The frame 14 may further include a header 17 and footer or sill 19. Alternatively, the lower portion of the opening 12 may be flush with the floor of the enclosure. One or more rollers 21 may be attached to the sill 19 or floor to facilitate movement of the slide out 20. A seal may be provided about the opening 12 to provide a weather tight seal between frame 14 and the slide out 20. A belt 40 may be used to extend and retract the slide out 20. As best shown in FIG. 2, belt 40 may be attached to either end of the slide out 20 by a suitable bracket or other fastener. In the example shown, a bracket 30 is used to attach the belt 40 at each of the outward end 43 and inward end 44 of belt 40. As best shown in FIG. 5, bracket 30 may include a base plate 32 that attaches to slide out 20 and an angle portion 34 that fits over belt 40 and base plate 32 to clamp the belt 40 therebetween. Angle portion 34 may include a lip 35 that extends parallel to the wall of the slideout 20, and an outward extending leg 36 that is perpendicular to lip 35 to act as a stop against the wall 13 of enclosure 10. Lip 35 may include a stepped raised portion 37 that defines a stepped notch in which the end of belt 40 and bracket 32 are received. A first pair of fasteners may be inserted in a first set of receivers 38 located outward of the stepped raised portion 37 and are used to first attach the bracket to slide out 20. With the bracket 30 in place, an end 43,44 of belt 40 is inserted within a central belt notch formed by raised portion 37. A second set of receivers 33 located in the lower step 39 of raised portion 37 outward of belt 40 are aligned with receivers 31 formed in base plate 32. With the belt 40 positioned in the belt notch, a second set of fasteners may be driven through receivers on lip 35 and base plate 32 to clamp the belt 40 between angle portion 34 and base plate 32. To facilitate this attachment, receivers 31 in base plate 32 may be slotted to make it easier to align base plate receivers 31 with second receivers 33 in angle portion 34.

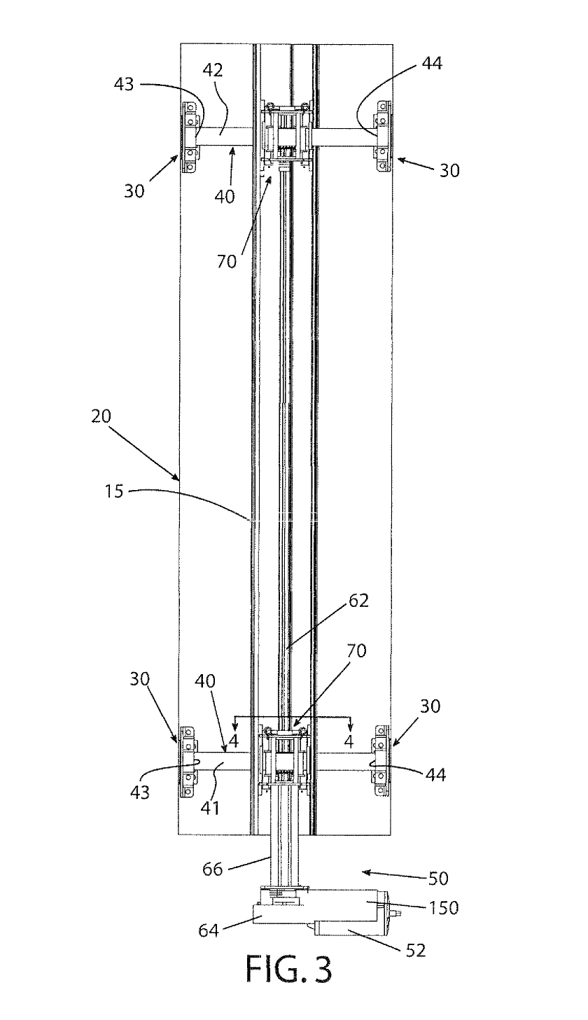

With reference to FIGS. 3-5, a drive assembly 50, according to the concepts of the present invention is shown. The drive assembly 50 is used to drive slide out 20 using a one or more belts, generally indicated by the number 40. In the example shown, a first belt 41 and a second belt 42 are provided on each side of the slide out 20. This example is not limiting and any number of belts may be used as required by a given application. In addition, as shown in FIG. 2, multiple drive assemblies 50 may be used to move slide out 20. In the example shown, a first drive assembly is located within jamb 15 on a left side of opening 12 and a second drive assembly 50 is located in the jamb 15 on the right side of opening 12. As shown, a separate motor may be used to drive each drive assembly. Alternatively, a common motor may be used to drive both drive assemblies through an appropriate coupling such as a synchronizing shaft. Other drive assembly configurations are possible including those having only a single drive assembly or more than two drive assemblies. For simplicity, only one drive assembly will be described. It will be appreciated that the drive assemblies on each side may be different from each other or a drive assembly may be provided on only one side of a slide out depending on the application.

The drive assembly 50, shown, includes a motor 52 operatively connected to a drive wheel 54 that engages belt 40 and rotates to pull belt 40 in one direction or the other depending on the direction of rotation. In the example shown, the drive wheel 54 includes cogs 56 on its outer surface 58 adapted to engage corresponding teeth 60 formed on belt 40. To that end, belt 40 may be of a type used as a timing belt in other applications. For example, a polyurethane belt having a steel core was found to be suitable. Other suitable materials may include but are not limited to polypropylene and ultra-high molecular weight polyethylene. The belt may be constructed of other suitable flexible materials or be constructed of non-flexible members pivotally linked to form a chain-like belt.

While motor 52 and drive wheel 54 may be directly connected to each other, to facilitate location of motor 52, motor 52 may be located remotely of drive wheel 54 and connected thereto by a coupler such as a drive shaft 62, as shown. Moreover, a gear box 64 or other transfer mechanism may be provided to mount motor 54 at an angle to drive shaft 62 or to provide a mechanical advantage through the gearing. In the example shown, motor 52 is mounted at a right angle to jamb 15 in which the drive wheel 54 in housed. In this way, motor 52 may be located within the frame 14 of enclosure 10 beneath opening 12. This may facilitate access to motor 52 for providing service and/or replacement. In addition, in the event of a motor failure, the motor 52 and gear box 64 may be removed to expose a stub shaft 69 extending from the drive shaft 62 to manually drive the slide out 20.

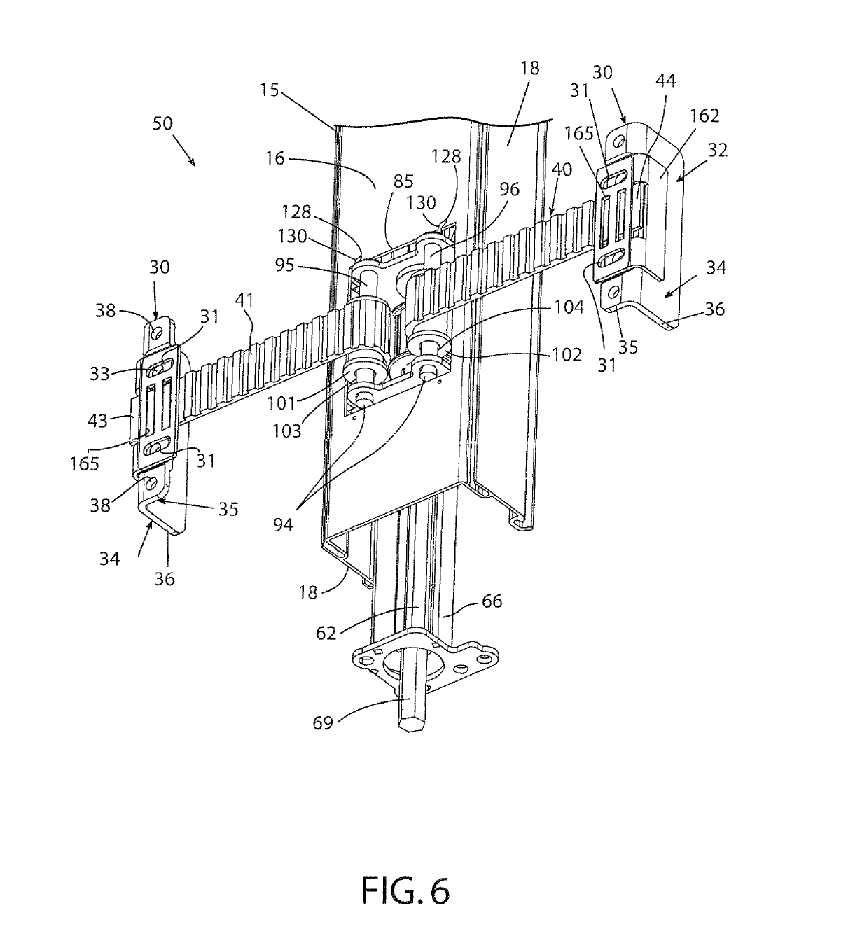

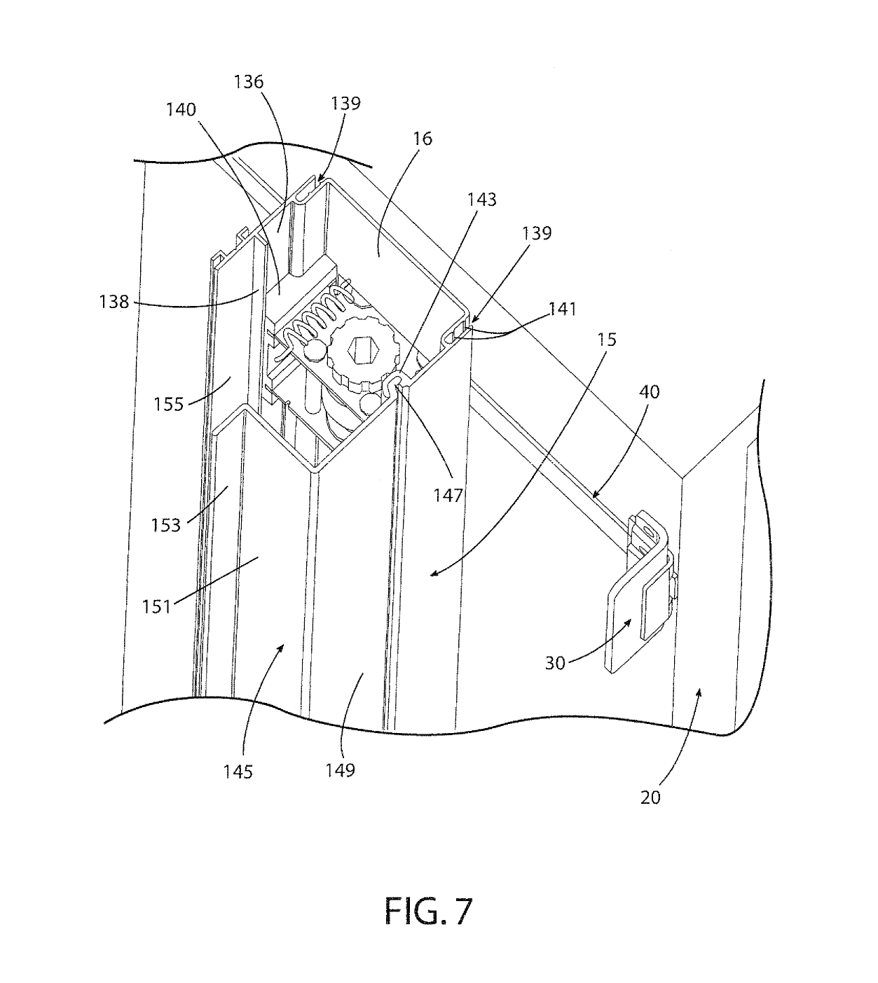

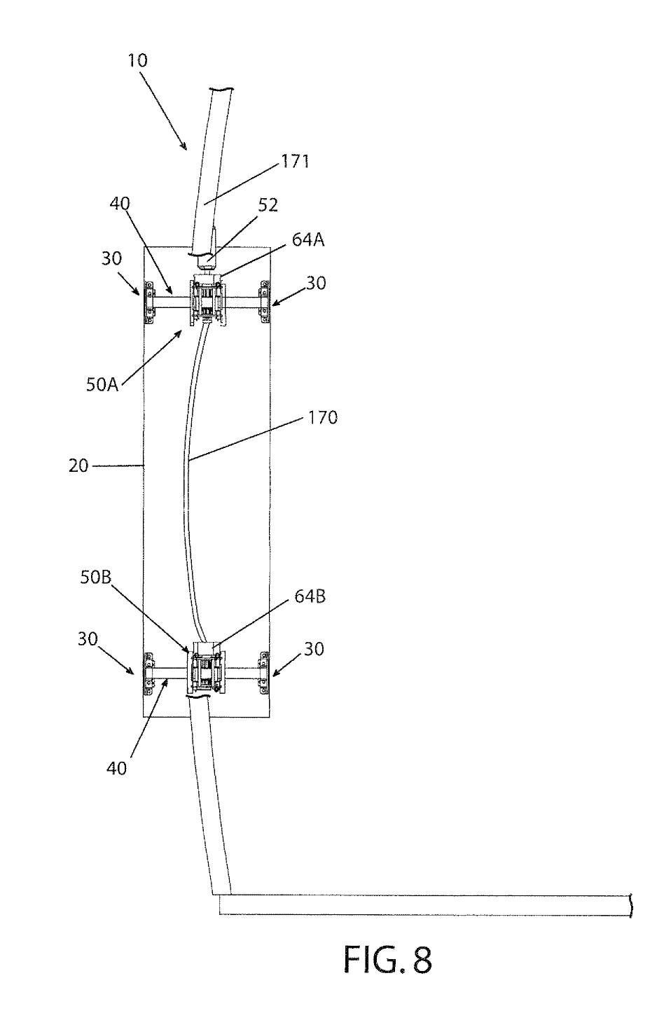

Gear box 64 is supported adjacent to motor 52 and connects to a portion of drive shaft 62 extending axially outward from jamb 15 on which the drive wheel 54 is mounted. A hex-shaped stub shaft 69 (FIG. 6) may be provided to couple drive shaft 62 to the motor 52 or gear box 64. To facilitate use of stub shaft 69, drive shaft 62 may have a hex-shape bore. The hex-shape stub shaft 69 may be driven manually by a wrench or socket. Alternatively, if the stub shaft if removed, a hex-shape tool, such as an alien wrench, may be inserted in the bore of drive shaft 62 to manually drive slide out 20. It will be appreciated that suitable air or electric driven tools may be connected via the stub shaft 69 or drive shaft 62 to provide an alternative motor drive when a dedicated motor is not used.

As shown, a drive shroud 66 may cover the portion of drive shaft 62 extending between gear box 64 and a cartridge 70 within which drive wheel 54 is mounted. As shown multiple drive wheels 54 may be mounted on a common drive shaft 62. Alternatively, each drive wheel 54 may be driven separately. Also, while a motor 52 is used arrive the drive wheel 54 in the depicted example, drive wheel 54 may be driven manually or a manual driver may be provided as discussed above.

With reference to FIG. 3, drive wheel 54 may be supported within a cartridge 70. In the example shown a first cartridge 71 is provided near the bottom 73 of jamb 15 and a second cartridge 72 is provided near the top 74 of jamb 15 to receive a first belt 41 and a second belt 42 associated with slide out 20. In this example, the first and second drive wheels 54 are mounted on a common drive shaft 62 driven by a single motor 52. In the depicted example, a pair of cartridges 70 are provided. Each cartridge has a pair of sidewalls 81,82, which may be formed by plates, that are generally located on either side of an opening 85 in jamb 15 through which belt 40 is received. First sidewall 81 and second sidewall 82 each define openings that are axially aligned with each other to form a drive shaft bore 80 through which drive shaft 62 is received. The sidewalls 81,82 may include a collar 83,84 (FIG. 5) or other reinforcement formed about the opening. The drive wheel 54 is carried on the drive shaft 62 between sidewalls 81,82 and is aligned with opening 85 in jamb 15. Drive wheel 54 is rotatably coupled to drive shaft 62. This may be accomplished by pinning or keying drive wheel 54 to drive shaft 62. Alternatively, as shown, an inner surface 55 of drive wheel 54 may define a drive wheel bore that mates with the outer surface 63 of drive shaft 62 to rotatably couple drive wheel 54 to drive shaft 62. For example, inner surface 55 of drive wheel 54 and outer surface 63 of drive shaft 62 may have a polygonal cross-section, such as a hex-shape, or, as shown, inner surface 55 of drive wheel 54 may define grooves 88 that mate with corresponding splines 90 formed on drive shaft 62. In any of these examples, drive wheel 54 may be allowed to slide along drive shaft 62 to prevent binding or to allow slide out 20 to move vertically. For example, to provide a flush floor slide out, the slide out may drop down once fully extended so that its floor is flush with the floor of the enclosure 10. Vertical movement of drive wheel 54 may be limited by the spacing between sidewalls 81,82.

Spacing of sidewalls 81,82 may be set by their mounting within jamb 15 or other spacer located between sidewalls 81,82. In the example shown, a pair of pins 92 act as a spacer and also connect the sidewalls 81,82 to each other. Pins 92 may be located outward of drive wheel 54 relative to belt opening 85 as best seen in FIG. 5. The pins 92 may also be spaced laterally outward of drive wheel 54. A second set of pins 94 may be located inward of drive wheel 54. Like the first set of pins 92, pins 94 may act as a spacer and provide support for sidewalls 81,82. Pins 94 are located inward of drive wheel 54, and, as shown may be positioned inward of belt opening 85 (FIG. 6).

The cartridge 70 may further include one or more guides that guide belt 40 to facilitate linear movement of slide out 20 and attachment of belt 40 to slide out 20. Guide may be any surface used to direct the belt 40. In the example shown, a first and second guides are provided in the form of a first roller 101 and a second roller 102. As shown, rollers 101,102 may have a spool-like form with outward extending edges at each axial extremity that help retain belt 40 on the rollers 101,102. Rollers 101,102 are spaced from each other and may be mounted on pins 94. Rollers 101,102 are located inward of drive wheel 54 and may extend through belt opening 85 in jamb 15. The first roller 101 and second roller 102 have axes of rotation located laterally outward of the drive wheel's axis of rotation ₜo route belt 40 laterally outward through belt opening 85. In the example shown, rollers 101,102 define bores 103,104 that receive first and second pins 95,96 and allow rollers 101,102 to rotate. It will be appreciated, however, that rollers 101,102 may be otherwise rotatably mounted. As with drive wheel 54 rollers 101,102 are slideable, and may move along the respective axes of pins 94 to allow relative vertical movement between slide out 20 and enclosure 10.

The walls of slide out 20 are not always regular and the distance between the wall of slide out 20 and jamb 15 may vary as slide out 20 is moved. To allow for such variation, cartridge 70 may be slideably mounted within jamb 15. To that end, inward/outward movement of drive wheel 54 and rollers 101,102 may be permitted. In the example shown, cartridge 70 is slideably mounted on jamb 15 on a mounting assembly 110 to permit such movement. Mounting assembly 110 includes a first mounting block 111 and second mounting block 112 supported on opposite sides of jamb 15 adjacent to belt opening 85. Each mounting block 111 defines a pair of grooves 115. The lateral outward edges 116,118 of sidewalls 81,82 are received in these grooves 115 and are permitted to slide therein.

To restrict movement of cartridge 70 and to bias the cartridge 70 toward belt opening 85, a biasing assembly, generally indicated by the number 125, may engage cartridge 70. Alternatively, if no cartridge 70 is used, biasing assembly 125 may act on drive wheel 54 and/or rollers 101,102 to the same effect when drive wheel 54 and rollers 104,102 are permitted to move inward or outward relative to slide out 20. It will be appreciated that the ends 43,44 of belts 41,42 may be secured at other locations on slide out 20 and through the use of other belt mounting mechanisms, including, but not limited to simple fasteners, clamps, and the like. In operation, motor 52 is driven in one direction to rotate drive wheel 54 in one direction causing drive wheel 54 to engage belt 40 and pull slide out 20 in one direction. Motor 52 may be driven in another direction or appropriate gearing used to cause drive shaft 62 to rotate in another direction to pull slide out 20 in the opposite direction. Motors 52 may be connected to a switch (not shown) that allows the user to selectively drive slide out 20 inward and outward relative to enclosure 10 as needed.

Biasing assembly 125 may include one or more biasing members including but not limited to springs, hydraulic and pneumatic members, elastomeric members, and the like. In the example shown, a pair of coil springs 126 are attached to jamb 15 at one end and to one of the sidewalls 81,82 of cartridge 70 at another end to urge cartridge 70 toward belt opening 85. To that end, jamb 15 is provided with a pair of receivers 128 through which a hook like extension 130 from spring 126 is received. Likewise, sidewall 81,82 includes a pair of spring receivers 132 at the outward edge 134 of the sidewall to receive hook-like ends 130 of springs 126 therein. The receivers 132 may be slots formed on the sidewall, and located laterally outward of the pins for the first and second rollers 101,102 it will be appreciated that a single spring may be used in place of the two springs. The pair of springs, shown, facilitates mounting of cartridge 70 when using a drive shaft 62 that extends through the cartridge 70. As best seen in FIG. 5, each sidewall 81, 82 of cartridge 70 may be provided with spring receivers, such as slots 132 to facilitate installation by allowing springs to be attached to either or both sides of cartridge 70. Alternatively, if a particular orientation of cartridge 70 is desired, the slots 132 may be provided on only one of the sidewalls.

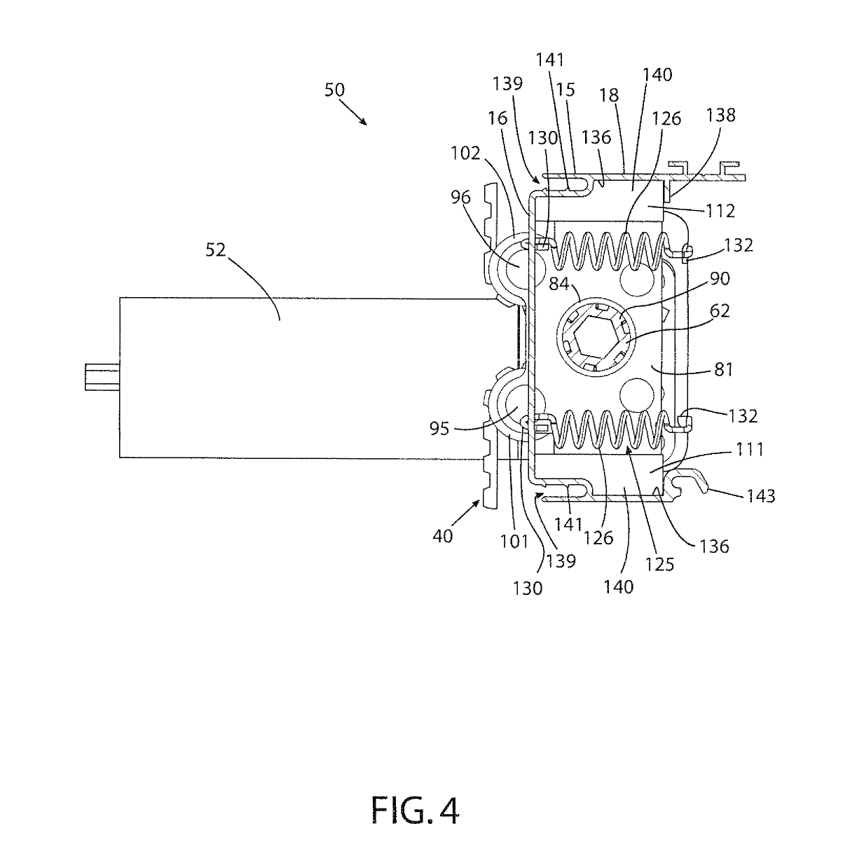

Mounting blocks 111 may be held by the contour of walls 18 of jamb 15. As best seen in FIG. 4, each wall 18 of jamb 15 may define a channel 136 between face 16 and a flange 138 on each wall of jamb 15.

Optionally, as shown in FIG. 7, channel 136 may be formed between receivers 139 formed adjacent to the face 16 of jamb 15. Receivers 139 are u-shaped members located on either side of face 16, and may include ribs or detents 141 that allow the jamb 15 to be snap fit onto frame members surrounding the opening 12. As a further option, a hook 143 may replace flange 138 on one side of jamb 15 to attach to a corresponding tab 147 on a channel member 145 that encloses the rear of jamb 15. Channel member 145 may include a first leg 149 extending parallel to wall 16 of jamb 15 and a second leg 151 that extends at an angle to first leg 149 and abuts an inner surface of the opposite wall 16. As shown, second leg 151 may extend along an outer surface of flange 138 to enclose the rear of jamb 15. In the example shown, a second tab 153 extends outward from second leg 151 and is braced against an inner surface 155 of wall 16 opposite hook 143 and necked tab 147. Hook 143 and necked tab 147 may be discrete members or be extruded as part of jamb 15 and channel member 145 and, thus, extend the entire length of the extruded structure, as shown. Adding optional receivers 139 and hook 143 facilitate installation by allowing securement of jamb 15 within opening 12 without additional fasteners.

Mounting block 111 may include a nose portion 140 that is received in channel 136 to hold the mounting block 111 in a direction transverse to the axis of jamb 15. Mounting block 111 may slide axially within jamb 15 to facilitate installation of mounting block 111 relative to belt opening 85. To fix the axial position of mounting blocks 111 relative to belt opening 85, jamb 15 may be provided with a pair of bendable tabs 142 on either side of belt opening 85. As shown, once mounting block 111 is positioned, tabs 142 bend inward at either end of mounting block 111 to fix its axial position by contacting the axial outward edges 144 of mounting block 111. Other structures may be used to fix the axial position of mounting blocks 111 including stops, pins, fasteners, and the like.

The mounting blocks 111 may be made of any material including but not limited to natural materials including wood, plastics, metals, or other composite materials. In the example shown, the mounting blocks are constructed of a plastic.

As depicted in FIG. 3, drive assembly may include a first belt 41 and a second belt 42 located near the top and bottom of jamb 15. To install the depicted drive assembly 50, first and second pairs of mounting blocks 111 are slideably inserted at either end of jamb 15. Each mounting block pair is positioned adjacent to first and second belt openings 85. First and second cartridges 70 are slideably received in the groove pairs formed by first and second pairs of mounting blocks 111 to place drive wheel 54 and rollers 101,102 in registry with each belt opening 85. Drive shaft 62 is inserted through bores 80 in first and second cartridges 70 and through each drive wheel 54, such that drive wheels 54 on jamb 15 are driven simultaneously. Drive shaft 62 may extend through an opening in frame 14 to couple to motor 52. A shroud 66 may be provided to enclose drive shaft 62 between motor 52 and jamb 15. The same installation process may be used to install a second drive assembly on an opposite jamb 15. A single motor may drive both drive assemblies through a mechanical assembly such as a flex shaft and gear box combination, or other suitable coupler. Alternatively, as shown, each drive assembly 50 may include its own motor 52. The motors 52 may be synchronized mechanically or electronically. In the example shown, the motors are synchronized through use of a counter, such as a Hall effect sensor associated with the armature of each motor 52 and monitored by a motor controller 150. If motor controller 150 detects that the motors are out of synch, it will adjust the speed of one or more of the motors 52 to bring them back into synchronization.

Ends 43,44 of belt 40 are routed from each drive wheel 54 over rollers 81,82 and laterally outward through belt opening 85 at each end of jamb 15. The ends 43,44 of each belt 41,42 are secured to portions of slide out 20 as by brackets 30. As discussed above, each end 43,44 of a belt 40 may be clamped by bracket 30 between a base plate 32 and an angle portion 34. In the example shown, base plate 32 is not fastened to slide out 20 and may slide within a range of motion limited by its attachment to angle portion 34. As one side of belt 40 is being pulled by drive wheel 54, some slack may form at the opposite end of belt 40. As best shown in FIG. 5, to help take up this slack, an insert 160 may be provided between a outward extending flange 162 extending from base plate 32 and angle portion 34 at each end of belt 40. The insert 160 is a compressible member that is compressed when drive wheel 54 pulls the belt away from insert 160. When tension is released from an end of the belt 40, insert 160 expands to take up any slack in belt 40. Insert 160 may be constructed of a rubber or polymer material, for example a phenolic or butylene rubber, that compresses and expands to maintain tension on belt 40. Alternatively, insert may include any other spring-like member that performs a similar tensioning function.

FIG. 8 shows another embodiment of the invention. This embodiment uses an alternative drive shaft 170 when mounting the drive assembly 50 in an enclosure 10 having a curved outer wall 171. To accommodate the curvature of outer wall 171, drive shaft 170 is a flex shaft and may curve between a first drive assembly 50A and a second drive assembly 50B as shown. It will be appreciated that the flex shaft 170 may be used in other applications to allow account for misalignment of the drive assemblies 50A,50B or otherwise facilitate installation or operation. In the example shown, a single motor 52 drives both drive assemblies 50A,50B. A first gear box 64A is provided between motor 52 and first drive assembly 50A, and a second gear box 64B is provided between first drive assembly 50A and second drive assembly 50B.

The foregoing written description uses examples to disclose the invention, including the best mode, and also to enable one of ordinary skill in the art to practice the invention, including making and using many devices or systems and performing any incorporated methods. The patentable scope of the invention is, however, defined by the claims, and may include other examples that occur to those skilled in the art. Such other examples are intended to be within the scope of the claims provided that the structural elements are within the literal language of the claims or include equivalent structural elements that are insubstantially different from the literal language of the claims.

1. A drive system for an expandable enclosure having a slide out, the drive system comprising:
a first guide;
a second guide spaced from the first guide;
a drive wheel rotatably supported between the first and second guides and inward thereof;
a belt operatively engaging the drive wheel and having a first end and a second end, wherein the first end extends outward from the drive wheel and over the first guide and the second end extends outward from the drive wheel and over the second guide, each of the ends being attachable to the slide out, wherein the drive wheel is rotatable to move the belt; and
wherein the first guide, second guide, and drive wheel are adapted to move vertically.

2. The drive system of claim 1, wherein the first guide and second guide are mounted on vertically extending pins, and slideable thereon, and wherein the drive wheel is mounted on a vertically extending drive shaft and slideable thereon.

3. The drive system of claim 1 further comprising a first bracket having a base plate and an angle portion, wherein an end of the belt is received between the base plate and the angle portion, a compressible insert located between the base plate and the end of the belt, wherein the angle portion is attachable to the slide out to compressibly attach the end of the belt to the slide out; and a second bracket having a base plate and an angle portion wherein an opposite end of the belt is received between the base plate and the angle portion of the second bracket, a second compressible insert located between the base plate of the second bracket and the opposite end of the belt, wherein the angle portion of the second bracket is attachable to the slide out opposite the first bracket to attach the opposite end of the belt to an opposite end of the slide out.

4. The drive system of claim 1, wherein the first guide is a first roller having an axis of rotation parallel to the drive wheel, and the second guide is a second roller having an axis of rotation parallel to the first roller.

5. The drive system of claim 1, wherein the drive wheel and the first and second guides are mounted within a cartridge, the cartridge being slideable inward and outward.

6. The drive system of claim 5 further comprising:
a jamb defining a channel in which the cartridge is received, the jamb further defining an opening through which the first and second ends of the belts extend;
a biasing member connected to the jamb and the cartridge to bias the cartridge toward the opening.

7. The drive system of claim 5 further comprising: a first mounting block and a second mounting block, the first mounting block respectively attachable to a first wall and a second wall of the jamb adjacent the opening, wherein the cartridge is slideably received between the first mounting block and the second mounting block.

8. The drive assembly of claim 6, wherein the cartridge includes a first sidewall and a second sidewall.

9. The drive assembly of claim 7, wherein the first and second mounting blocks each include a pair of slots adapted to slidably receive respective edges of the first and second sidewalls.

10. The drive assembly of claim 8, wherein the first wall of the jamb includes a first flange extending inward therefrom, and the second wall of the jamb includes a second flange extending inward therefrom, the first flange defining a first contour on the first wall of the jamb and the second flange defining a second contour on the second wall of the jamb, wherein the first mounting block and the second mounting block include nose portions extending laterally outward, the nose portions being received in respective contours on the first and second walls of the jamb.

11. The drive assembly of claim 10, wherein first and second mounting blocks are slideable within the first and second contours, the first flange including a pair of tabs engagabie with respective ends of the first mounting block and the second flange including a second pair of tabs engagabie with respective ends of the second mounting block.

12. The drive system of claim 7 further comprising a biasing assembly urging the cartridge toward the opening in the jamb.

13. The drive system of claim 8, further comprising a pair of springs attached to the jamb and one of the sidewalls of the cartridge, the pair of springs being adapted to urge the cartridge toward the opening in the jamb.

14. The drive system of claim 8, wherein the first sidewall and the second sidewall of the cartridge respectively define a first drive opening and a second drive opening, the first drive opening and the second drive opening being axially aligned, a drive shaft received in the first drive opening and second drive opening, wherein the drive wheel is rotatably fixed to the drive shaft.

15. The drive system of claim 1, wherein the drive wheel is supported on a drive shaft, the drive wheel and drive shaft being rotatably fixed, relative to each other such that the drive wheel rotates with the drive shaft.

16. The drive system of claim 15, wherein the drive wheel and drive shaft are rotatably fixed by wheel splines formed on an interior surface the drive wheel and shaft splines formed on an exterior surface of the drive shaft.

17. The drive system of claim 15, wherein the drive shaft defines a hexagonal inner bore.

18. The drive system of claim 17 further comprising a stub shaft having a hexagonal cross section, the stub shaft being received in the hexagonal bore and having a coupling surface extending outward thereof.

18. The drive system of claim 15, wherein the drive shaft is coupled to a motor.

19. The drive system of claim 18, wherein the motor is housed within a jamb.

20. A cartridge in a drive system having a belt for an expandable enclosure, the cartridge comprising:
a first sidewall and a second side wall;
a first pin extending between the first sidewall and the second sidewall;
a first roller defining a first roller bore through which the first pin is received, wherein the first roller is slideable along the first pin between the first sidewall and the second sidewall; and
a drive wheel supported between the first sidewall and the second sidewall, the drive wheel being engagable with the belt and rotatable to cause relative movement of the expandable enclosure via the belt, wherein the drive wheel is slideably mounted to move along an axis parallel with the first pin.

21. The cartridge of claim 20 further comprising:
a second pin extending between the first sidewall and the second sidewall;
a second roller defining a first roller bore through which the second pin is received, wherein the second roller is slideable along the second pin between the first sidewall and the second sidewall, and wherein the drive wheel is located between the first roller and the second roller and outward of the first roller and the second roller.

22. The cartridge of claim 21, wherein the first pin and the second pin lie in a common plane and are parallel to each other.

23. The cartridge of claim 20 further comprising a biasing assembly attachable to at least one of the first sidewall and second sidewall and adapted to urge the cartridge inward.

24. The cartridge of claim 23, wherein the biasing assembly includes a pair of springs.

25. The cartridge of claim 20 further comprising a first mounting block and a second mounting block, each of the first mounting block and second mounting block defining a pair of grooves therein, wherein the first mounting block and the second mounting block collectively define a first groove pair at one end and a second groove pair at another end; and
wherein the first sidewall and second sidewall each have edges extending outward of the first pin and second pin, the edges of the first sidewall being received in the first groove pair and the edges of the second sidewall being received in the second groove pair, wherein the edges of the first sidewall and the second sidewall are slideable within the first groove pair and the second groove pair.

26. An expandable enclosure comprising:
a main enclosure defining an opening;
a slide out received in the opening;
a jamb defining a side of the opening, the jamb including a face, a first wall extending outward from the face, a second wall extending outward from the face, and a channel defined between the first wall and the second wall, wherein the face defines a first belt opening
a cartridge mounted within the channel adjacent to the first belt opening, the cartridge having a first sidewall and a second sidewall, a first pin extending between the first sidewall and the second sidewall, a first roller mounted on the first pin and slideable between the first wall and the second wall, and a drive wheel supported between the first sidewall and the second sidewall, the drive wheel having an axis of rotation parallel to the first roller, wherein the drive wheel is mounted outward of the first roller; and
a belt operatively engaging the drive wheel, wherein a portion of the belt extends from the drive wheel and over the first roller before exiting the belt opening, the portion of the belt being attached to the slide out.

27. The expandable enclosure of claim 26 further comprising:
a second pin extending between the first sidewall and the second sidewall, wherein the second pin extends parallel to the first pin;
a second roller mounted on the second pin and slideable between the first wall and the second wall, wherein the drive wheel is located between the first roller and the second roller and wherein a second portion of the belt extends outward from the drive wheel over the second roller before exiting the belt opening, the second portion of the belt being attached to another end of the slide out.

28. The expandable enclosure of claim 26, wherein the belt has plural teeth; and wherein the drive wheel has at least one tooth engagable with the teeth on the belt.

29. The expandable enclosure of claim 26, wherein the jamb defines a second belt opening; a second cartridge being supported within the channel of the jamb adjacent to the second belt opening, the second cartridge having a first sidewall and a second sidewall, a first pin extending between the first sidewall and the second sidewall, a first roller mounted on the first pin and slideable between the first wall and the second wall, and a second drive wheel supported between the first sidewall and the second sidewall, the second drive wheel having an axis of rotation parallel to the first roller, wherein the second drive wheel is mounted outward of the first roller; and
a second belt operatively engaging the drive wheel, wherein a portion of the second belt extends from the second drive wheel and over the first roller of the second cartridge before exiting the second belt opening, the portion of the second belt being attached to the slide out.

30. The expandable enclosure of claim 29, wherein each cartridge further comprises a second pin extending between the first sidewall and the second sidewall, wherein the second pin extends parallel to the :first pin;
a second roller mounted on the second pin and slideable between the first wall and the second wall;
wherein the drive wheel on the first cartridge is located between the first roller and the second roller of the first cartridge and wherein the second drive wheel is located between the first roller and the second roller on the second cartridge;
a second portion of the belt extends outward from the drive wheel over the second roller before exiting the belt opening, the second portion of the belt being attached to an end of the slide out opposite the first portion of the belt; and
a second portion of the second belt extends outward from the second drive wheel over the second roller in the second cartridge before exiting the second belt opening, the second portion of the second belt being attached to an end of the slide out opposite the first portion of the second belt.

31. The expandable enclosure of claim 30 further comprising a drive shaft; wherein the first sidewall and second sidewall of the cartridges each define a shaft opening through which the drive shaft is received, and wherein the drive wheel and the second drive wheel are mounted on the drive shaft and rotatably coupled thereto.

32. The expandable enclosure of claim 31, further comprising a motor coupled to the drive shaft.

33. A drive assembly for a slide out located between a first jamb and a second jamb within an enclosure, the drive assembly comprising:
a first drive shaft housed within the first jamb and a second drive shaft housed within the second jamb;
a first drive wheel mounted on the first drive shaft in registry with a first belt opening formed in the first jamb, wherein the first drive wheel is slidable on the first drive shaft;
a second drive wheel mounted on the second drive shaft in registry with a second belt opening formed in the second jamb, wherein the second drive wheel is slidable on the second drive shaft;
a first belt coupled to the first drive wheel and attachable to the slide out;
a second belt coupled to the second drive wheel and attachable to the slide out.

34. The drive assembly of claim 33 further comprising a first motor operatively connected to the first drive shaft; a second motor operatively connected to the second drive shaft.

35. The drive assembly of claim 34 further comprising a motor controller electrically connected to the first motor and the second motor and adapted to receive a counter signal from each motor indicative of relative motor speed between the first motor and the second motor, wherein the motor controller is adapted to vary the speed of at least one of the motors to synchronize the first motor and the second motor.

36. The drive assembly of claim 35 further comprising a Hall effect sensor associated with each of the motors, wherein the Hall effect sensor generates the counter signal.

37. The drive assembly of claim 34, wherein the first motor is housed in the first jamb, and the second motor is housed in the second jamb.

38. The drive assembly of claim 33 wherein the first drive shaft and the second drive shaft are coupled together, and a motor operatively attached to one of the drive shafts to drive both drive shafts.

39. The drive assembly of claim 38, wherein the first drive shaft is attached to a first gear box, and the second drive shaft is attached to a second gear box, wherein the first drive shaft and the second drive shaft are coupled through the first and second gear boxes.

40. The drive assembly of claim 39, wherein the first gear box and the second gear box are coupled by a flex shaft.
